(19) United States
(12) Patent Application Publication
(10) Pub. No.: US 2023/0388599 A1
(43) Pub. Date: Nov. 30, 2023

(54) PLACING ORDERS FOR A SUBJECT INCLUDED IN A MULTIMEDIA SEGMENT OF A CONTENT CHANNEL

(71) Applicant: Roku, Inc., San Jose, CA (US)

(72) Inventor: Santosh Eppalapally, San Jose, CA (US)

(73) Assignee: Roku, Inc., San Jose, CA (US)

(21) Appl. No.: 17/752,376

(22) Filed: May 24, 2022

(51) Int. Cl. H04N 21/478; G06Q 20/32; G06Q 20/08; H04N 21/845

(52) U.S. Cl. CPC H04N 21/47815; G06Q 20/3267; G06Q 20/0855; H04N 21/8455

(57) ABSTRACT

Disclosed herein are system, apparatus, method and/or computer program product embodiments for a multimedia environment that includes a computing device coupled to a mobile device and other components. The computing device can associate subject catalog metadata with one or more subjects included in a multimedia segment received from a user, place the multimedia segment into a content channel assigned to the user, present the multimedia segment included in the content channel to the mobile device operated by a consumer, and place an order through the mobile device for a subject selected from the one or more subjects included in the multimedia segment based on the subject catalog metadata. The computing device can also present the multimedia segment to another device in synchronization with the presenting the multimedia segment to the mobile device, and receive a consumer input from a remote control associated with another device to place another order.

### BACKGROUND

### Field

This disclosure is generally directed to commerce including live commerce conducted based on multimedia technology.

### Background

Commerce refers to the activity of buying and selling, which is fundamental to the society throughout the human history. A technology can change the way commerce is conducted. For example, using television (TV), a consumer can watch TV while placing orders for items in a shopping channel of TV programs. With the advance of computer technology, e-commerce has fundamentally changed the way commerce is conducted. However, it is still desired to improve the efficiency of commerce with current technologies.

### SUMMARY

Provided herein are system, apparatus, article of manufacture, method and/or computer program product embodiments, and/or combinations and sub-combinations thereof, for live commerce to enable a consumer to place an order for a subject included in a multimedia segment of a content channel displayed in a mobile device and/or other multimedia device in a multimedia environment.

An example embodiment of a multimedia environment includes a mobile device and a computing device which can serve as a media device. The computing device can associate subject catalog metadata with one or more subjects included in a multimedia segment received from a user, and place the multimedia segment into a content channel. In some embodiments, the content channel can be assigned to the user. The computing device can further present the multimedia segment included in the content channel to a mobile device operated by a consumer.

In some embodiments, the computing device can further manage multiple content channels, and select the content channel assigned to the user to be presented to the mobile device operated by the consumer based on a profile associated with the mobile device or the consumer. In some embodiments, the computing device can select the content channel by first presenting multiple indications of multiple content channels including the content channel assigned to the user to the mobile device, and receive an indication from the consumer for selecting the content channel assigned to the user to be presented to the mobile device.

In some embodiments, the computing device can further place an order for the consumer through the mobile device for a subject selected from the one or more subjects included in the multimedia segment based on the subject catalog metadata. In placing the order, the computing device can send to the mobile device further information of the one or more subjects for the consumer to select the one or more subjects for the order, where the information of the one or more subjects can include a size of the one or more subjects, a color of the one or more subjects, a quantity of the one or more subjects, a functional feature of the one or more subjects, or a sales promotion information for the one or more subjects.

In some embodiments, in addition to the mobile device, the computing device can present the multimedia segment included in the content channel to another device in synchronization with the presenting the multimedia segment included in the content of the channel to the mobile device, and receive a consumer input from a remote control associated with another device coupled to the computing device to place another order.

In addition, the computing device can process the order to obtain information about the consumer, shipping information, or payment information for the order. The order can include payment information, and the computing device can facilitate a payment for the order based on the payment information included in the order. In some embodiments, the computing device can further notify by an email or a text message through the mobile device to the consumer that the order is placed successfully. In some other embodiments, upon a failure to validate at least a portion of the order by a third party shopping system, the computing device can receive an indication that the order is not placed successfully.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates an example multimedia environment for placing an order for a subject included in a multimedia segment of a content channel displayed in a mobile device, according to some embodiments.

FIG. 4 illustrates an example process for placing an order for a subject included in a multimedia segment of a content channel displayed in a mobile device, according to some embodiments.

FIGS. 5A-5F illustrate example steps of a process performed by a mobile device to placing an order for a subject included in a multimedia segment of a content channel displayed in the mobile device, according to some embodiments.

FIG. 6 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Commerce refers to the activity of buying and selling, which is fundamental to the society throughout the human history. A technology can change the way commerce is conducted. For example, using television (TV), a consumer can watch TV while placing orders for items in a shopping channel. However, in order to market the subjects in the shopping channel, the seller normally has to buy time slots from cable channel operators, and can only reach people with cable TV subscriptions. With the advance of computer technology, e-commerce has fundamentally changed the way commerce is conducted. For example, some companies may operate a website to sell many kinds of merchandises. However, selling subjects through websites is mostly based on text and static representation of the subject, which can limit the representation of information related to the subject. In addition, the access to the website may be limited by the availability of a web browser the buyer has to use to browse the website and buy the subject. Live streaming of influencers may sell subjects in real-time over the stream media. However, the real-time selling may also limit the access of the consumers since the consumers have to watch the selling activities based on the seller's schedule.

One trend shaping advertising is the rapid rise of streaming video viewership. A new medium known as over-the-top (OTT) advertising has emerged, allowing brands to reach their audiences directly within their living rooms. T-Commerce is a term describing trade via smart digital TV-set that can act as a marketing channel in addition to its main functionality of displaying media content. T-Commerce can use a media system to enable bidirectional communication, interactive advertising and addressable advertising. However, T-Commerce may be limited to selling using advertisement embedded into normal media contents.

Embodiments herein present live commerce, which can provide a more flexible and yet dedicated platform for the sellers and consumers alike. A user or seller can upload a multimedia segment to a content channel. A content channel can include multiple multimedia segments provided by a user or a content creator, or related to some subjects. A content channel can be referred to as a streaming channel as well. A content channel can be displayed in a mobile device or in a display device that is used to display media content. A computing device or a media device can manage multiple content channels for many users at the same time. A consumer or a viewer may be presented with the choice of many content channels, select which content channel to watch, and place an order using a mobile device. As a result, the consumer or the viewer can see different content channels based on the consumer's profile. In some embodiments, the different content channels can be made available based on a recommendation system to recommend the content channels from a pool of content channels. Hence, embodiments herein can have a personalized channels for a consumer based on the consumer's profile. As such, embodiments herein can present channels in a fundamentally different way from cable channels, where cable channels can take bandwidth, operational challenges to create multiple channels. With the wide spread usage of mobile device, embodiments herein can provide access to consumers anywhere at any time.

An example embodiment of a multimedia environment for live commerce can include a computing device, a media server system, a third party shopping system, a mobile device used by a consumer, and a user device used by a content creator. The content creator can provide a multimedia segment through the user device, where the multimedia segment can include one or more subjects. The computing device can place the multimedia segment into a content channel, and further send the multimedia segment in the content channel to the mobile device or a display device. The content channel can be displayed simultaneously at the mobile device or the display device. The computing device can further place an order for the consumer through the mobile device for a subject selected from the one or more subjects included in the multimedia segment based on the subject catalog metadata. Users today are often active on multiple devices. A user may be watching TV while simultaneously active on a mobile phone or mobile device. A mobile app or software application operating on the mobile phone or mobile device can determine the products based on the stream being played on the TV and thus checkout flow can be completed on the mobile device. A combination of TV plus a mobile app on a mobile device can provide better user experience leveraging context of stream plus logged in user.

Live commerce presented in embodiments herein can be an improvement over the current E-commerce based on website where text is primarily used. In addition, a content channel is different from a website address in that a content channel can be displayed in multiple different devices, where some device may not have the capability to operate a web browser. Live commerce can also be an improvement over the streaming of influencer selling a subject in real time, where the multimedia segment provided by a user to a content channel can make the selling of the subject included in the multimedia segment and buying by a consumer in the mobile device asynchronous to improve accessibility. In some embodiments, live commerce can include channels for live streaming in real time as well.

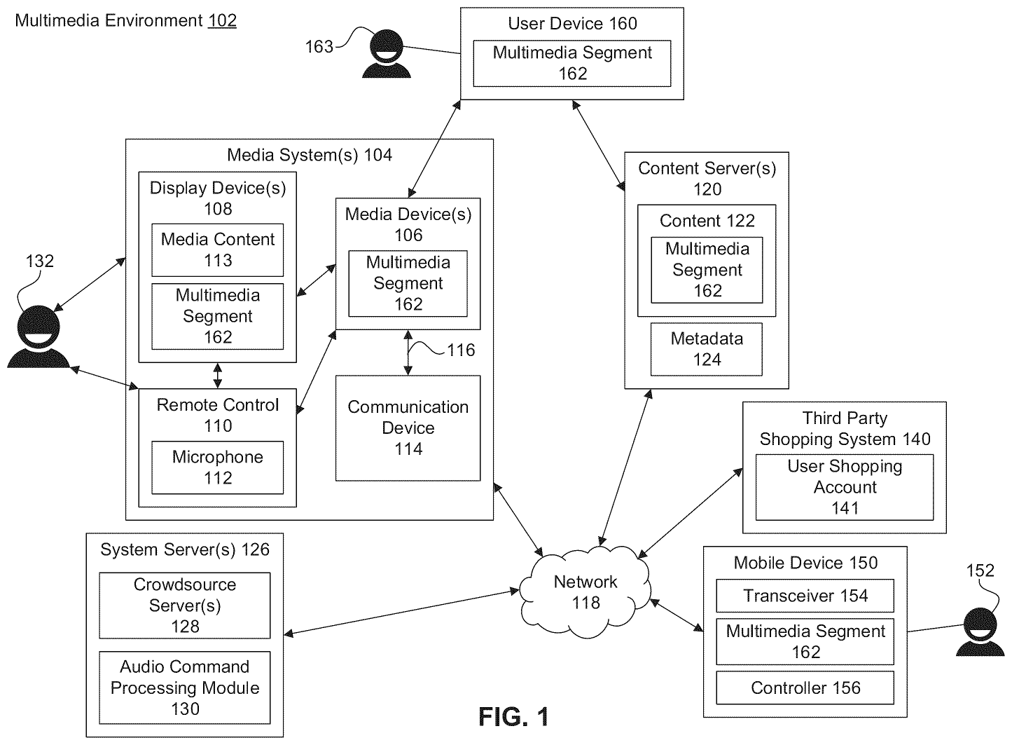

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to multimedia environment 102, as will be appreciated by persons skilled in the relevant art(s) based on the teachings contained herein. An example of multimedia environment 102 shall now be described.

Multimedia Environment

FIG. 1 illustrates a block diagram of multimedia environment 102, according to some embodiments. Multimedia environment 102 illustrates an example environment, architecture, ecosystem, etc., in which various embodiments of this disclosure may be implemented. However, multimedia environment 102 is provided solely for illustrative purposes, and is not limiting. Embodiments of this disclosure may be implemented and/or used in environments different from and/or in addition to multimedia environment 102 of FIG. 1, as will be appreciated by persons skilled in the relevant art(s) based on the teachings contained herein.

In a non-limiting example, multimedia environment 102 may be directed to streaming media. However, this disclosure is applicable to any type of media (instead of or in addition to streaming media), as well as any mechanism, means, protocol, method and/or process for distributing media.

Multimedia environment 102 may include one or more media systems 104. Media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with media system 104 to select and consume content. User 132 may interact with media system 104 through a remote control 110. User 132 may be a viewer, a consumer, or both.

Each media system 104 may include one or more media devices 106 each coupled to one or more display devices 108. Media device 106 may be referred to as a computing device as well. It is noted that terms such as “coupled,” “connected to,” “attached,” “linked,” “combined” and similar terms may refer to physical, electrical, magnetic, logical, etc., connections, unless otherwise specified herein.

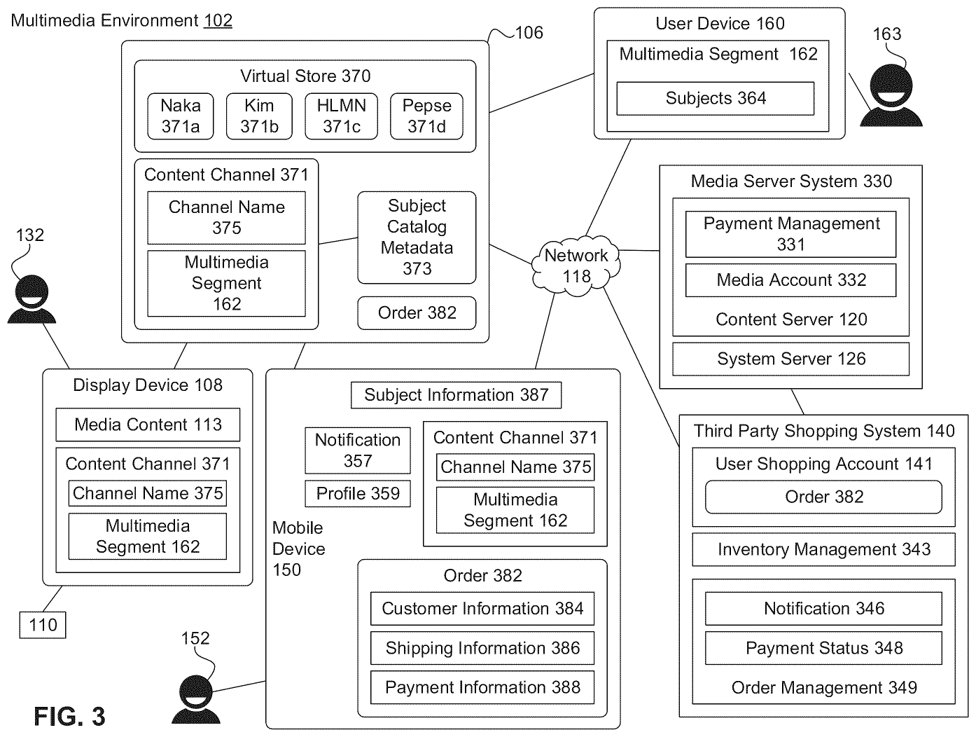

Media device 106 may be a streaming media device, a streaming set-top box (STB), cable and satellite STB, a DVD or BLU-RAY device, an audio/video playback device, cable box, and/or a digital video recording device, to name just a few examples. Display device 108 may be a monitor, a television (TV), a computer, a computer monitor, a smart phone, a tablet, a wearable (such as a watch or glasses), an appliance, an internet of things (IoT) device, and/or a projector, to name just a few examples. In some embodiments, media device 106 can be a part of, integrated with, attached to, operatively coupled to, and/or connected to its respective display device 108. Media device 106 can provide media content 113 to display device 108. In addition, media device 106 can provide a multimedia segment 162 included in a content channel to be displayed on display device 108 with more details shown in FIG. 3.

Each media device 106 may be configured to communicate with network 118 via a communication device 114. Communication device 114 may include, for example, a cable modem or satellite TV transceiver. Media device 106 may communicate with communication device 114 over a link 116, where link 116 may include wireless (such as WiFi) and/or wired connections.

In various embodiments, network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. Remote control 110 can be any component, part, apparatus and/or method for controlling media device 106, display device 108, such as a remote control, a tablet, laptop computer, smartphone, wearable, on-screen controls, integrated control buttons, audio controls, or any combination thereof, to name just a few examples. In an embodiment, remote control 110 wirelessly communicates with media device 106, or display device 108 using cellular, Bluetooth, infrared, etc., or any combination thereof.

Multimedia environment 102 may include a plurality of content servers 120 (also called content providers). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form. Content 122 may be the source for media content 113 displayed on display device 108. In addition, multimedia segment 162 may be stored as a part of content 122.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to content 122. Metadata 124 may also or alternatively include links to any such information pertaining or relating to content 122. Metadata 124 may also or alternatively include one or more indexes of content 122, such as but not limited to a trick mode index.

Multimedia environment 102 may include one or more system servers 126. System servers 126 may operate to support media device 106 from the cloud. It is noted that the structural and functional aspects of system servers 126 may wholly or partially exist in the same or different ones of system servers 126. System servers 126 and content server 120 together may be referred to as a media server system. An overall media system may include a media server system and media system 104. In some embodiments, a media system may refer to the overall media system including the media server system and media system 104.

Media devices 106 may exist in thousands or millions of media systems 104. Accordingly, media devices 106 may lend themselves to crowdsourcing embodiments and, thus, system servers 126 may include one or more crowdsource servers 128.

For example, using information received from media devices 106 in the thousands and millions of media systems 104, crowdsource server(s) 128 may identify similarities and overlaps between closed captioning requests issued by different users 132 watching a particular movie. Based on such information, crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, crowdsource server(s) 128 may operate to cause closed captioning to be automatically turned on and/or off during future streaming of the movie.

System servers 126 may also include an audio command processing module 130. As noted above, remote control 110 may include a microphone 112. Microphone 112 may receive audio data from user 132 (as well as other sources, such as display device 108). In some embodiments, media device 106 may be audio responsive, and the audio data may represent verbal commands from user 132 to control media device 106 as well as other components in media system 104, such as display device 108.

In some embodiments, the audio data received by microphone 112 in remote control 110 is transferred to media device 106, which is then forwarded to audio command processing module 130 in system servers 126. Audio command processing module 130 may operate to process and analyze the received audio data to recognize a verbal command from user 132. Audio command processing module 130 may then forward the verbal command back to media device 106 for processing.

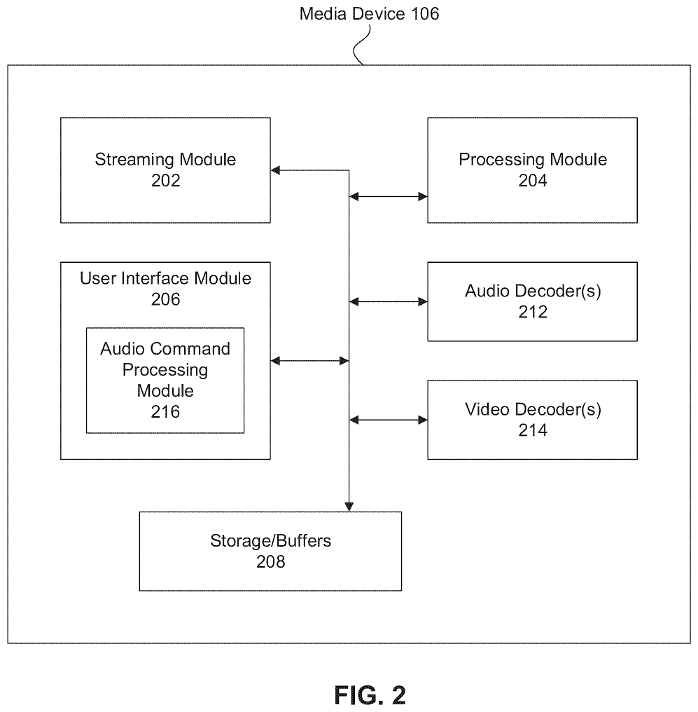

In some embodiments, the audio data may be alternatively or additionally processed and analyzed by an audio command processing module 216 in media device 106 (see FIG. 2). Media device 106 and system servers 126 may then cooperate to pick one of the verbal commands to process (either the verbal command recognized by audio command processing module 130 in system servers 126, or the verbal command recognized by audio command processing module 216 in media device 106).

In some embodiments, multimedia environment 102 may include a third party shopping system 140. Third party shopping system 140 may provide advertisement including advertised subject to be displayed on display device 108. Third party shopping system 140 can also receive an order placed by various parties, users, consumers, and transferred from various devices such as media device 106, and record the order in a user shopping account 141 managed by the third party shopping system.

In some embodiments, multimedia environment 102 may include a user device 160 accessed by a user 163, and a mobile device 150 accessed by a user or consumer 152. User 163 may be a company, an advertiser, a content creator, a marketing person that can access user device 160 to upload multimedia segment 162 to be managed by a computing device, e.g., media device 106 or content sever 120. Instead of being a human being, user 163 can be a machine communicating with media device 106 or content sever 120. Multimedia segment 162 can include information for one or more subjects. The computing device, such as media device 106 or content sever 120, can place multimedia segment 162 into a content channel assigned to the user 163, and present the multimedia segment 162 included in the content channel to the mobile device 150 operated by a user or consumer 152. The computing device, such as media device 106 or content sever 120, can place an order for the consumer 152 through the mobile device 150 for a subject selected from the one or more subjects included in the multimedia segment 162 based on subject catalog metadata. In addition, the computing device, such as media device 106 or content sever 120, can present the multimedia segment 162 included in the content channel to another device, such as display device 108, in synchronization with the presenting the multimedia segment 162 included in the content of the channel to the mobile device 150. The computing device, such as media device 106 or content sever 120, can further receive a consumer input from remote control 110 associated with another device, such as display device 108, to place another order.

In some embodiments, mobile device 150 can include a transceiver 154 configured to wirelessly communicate with a computing device, and a controller 156 coupled to the transceiver and configured to perform various operations. Communication between mobile device 150 with the computing device such as media device 106 or content sever 120 may be through transceiver 154 and network 118. More details of the operations of user device 160, mobile device 150, and the computing device, such as media device 106 or content sever 120 are shown in FIGS. 3, 4, 5A-5F, and 6.

In some embodiments, mobile device 150 can include a handheld terminal, a cellular phone (e.g., a smart phone), a personal digital assistant (PDA), a wireless modem, a wireless communication device, a handheld device, a laptop, a desktop, a cordless phone, a wireless local loop station, a tablet, a camera, a gaming device, a netbook, an ultrabook, a wearable device (smart watch, smart clothing, smart glasses, smart wrist band, smart jewelry such as smart ring or smart bracelet), an entertainment device (e.g., a music or video device, or a satellite radio), a vehicular component, an Internet-of-Things (IoT) device, a machine-type communication (MTC) device, an evolved or enhanced machine-type communication (eMTC) device, or any other suitable device that is configured to communicate via a wireless medium.

FIG. 2 illustrates a block diagram of an example media device 106, according to some embodiments. Media device 106 may include a streaming module 202, a processing module 204, a storage/buffers 208, and a user interface module 206. As described above, user interface module 206 may include audio command processing module 216.

Media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, user 132 may interact with media device 106 via, for example, remote control 110. For example, user 132 may use remote control 110 to interact with user interface module 206 of media device 106 to select content, such as a movie, TV show, music, book, application, game, etc. Streaming module 202 of media device 106 may request the selected content from content server(s) 120 over network 118. Content server(s) 120 may transmit the requested content to streaming module 202. Media device 106 may transmit the received content to display device 108 for playback to user 132. Mobile device 150 may provide additional control and communication with media device 106 or third party shopping system 140.

In streaming embodiments, streaming module 202 may transmit the content to display device 108 in real time or near real time as it receives such content from content server(s) 120. In non-streaming embodiments, media device 106 may store the content received from content server(s) 120 in storage/buffers 208 for later playback on display device 108.

Coordination Between a Media Device, a Mobile Device, and a Display Device.

FIG. 3 illustrates more details of a part of multimedia environment 102 for placing an order for a subject included in multimedia segment 162 of a content channel displayed in mobile device 150. As described in FIG. 1, multimedia environment 102 includes media systems 104 that includes media device 106, display devices 108, and remote control 110; content server 120 and system server 126 that together can form a media server system 330; third party shopping system 140; user device 160 and mobile device 150. Media device 106 or media server system 330 may be referred to as a computing device as well. Operations performed between user device 160 and a computing device may be between user device 160 and media device 106 or media server system 330. In some embodiments, media server system 330 can be a system different from third party shopping system 140.

In some embodiments, media device 106 can be associated with a media account 332 managed by media server system 330. For example, media account 332 can be saved in content server 120, and media account 332 can uniquely identify media device 106. Media server system 330 may be communicatively coupled to multiple third party shopping systems.

In some embodiments, media device 106 can provide media content 113 to display device 108. Media content 113 can be provided to media device 106 by media server system 330, such as by content server 120. Media content 113 can be provided by media server system 330 according to media account 332 associated with media device 106 managed by media server system 330. In some embodiments, media content 113 can be provided according to subscriptions associated with media account 332.

In some embodiments, user 163 can provide multimedia segment 162 to user device 160. Multimedia segment 162 can be in various format, such as text, video, audio, or a mixed of some or all of text, video, audio. Multimedia segment 162 can be created before being provided to user device 160 instead of being live streamed. Hence, content of multimedia segment 162 can have more flexibility than being live streamed. Multimedia segment 162 can include information about one or more subjects, which can be simply referred to as subject 364, or one or more subjects 364. Subject 364 can be related to a product, an object that is tangible, a service, or anything that can be bought or sold. In some embodiments, multimedia segment 162 can contain only information related to selling one or more subjects. In some other embodiments, multimedia segment 162 can contain normal entertainment content, such as a movie, in addition to information related to selling one or more subjects. When the brand/creator/seller uploads multimedia segment 162, metadata about products or subjects can be embedded into multimedia segment 162, the metadata about products or subjects may inform which products or subjects are available during the time window in the below format:
00:00-1:00 Kim Perfume, sku: abc123, price: 20
1:00-2:00 Kim Deodrant, sku: abc124, price: 30
2:00-3:00 Kim LipStick, sku: abc125, price: 10

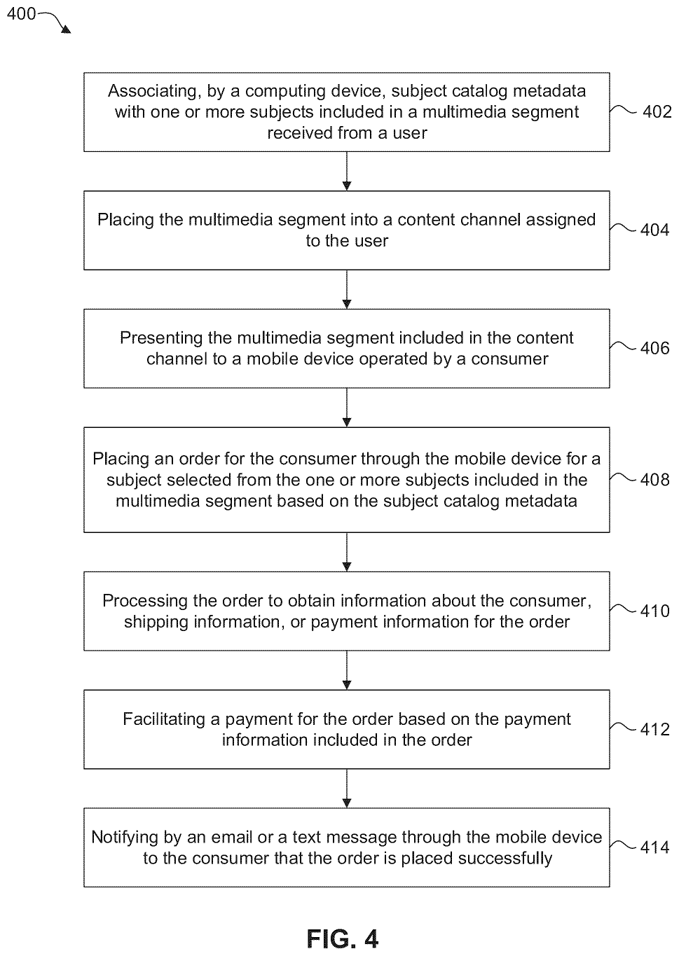

Furthermore, multimedia segment 162 can be transmitted to a computing device, such as media device 106, where further operations related to multimedia segment 162 can be performed, such as operations of process 400 shown in FIG. 4. A display device such as a TV screen showing a live TV video of creator Kim can show a product which can be purchased either through the display device or a mobile app operating on mobile device 150.

FIG. 4 illustrates an example process 400 for placing an order for subject 364 included in multimedia segment 162 of a content channel displayed in mobile device 150, according to some embodiments. In some embodiments, process 400 can be performed by a computing device, such as media device 106 or media server system 330. Descriptions below may use media device 106 as an example of a computing device. Processes 400 can be performed by processing logic that can comprise hardware (e.g., circuitry, dedicated logic, programmable logic, microcode, etc.), software (e.g., instructions executing on a processing device, such as by controller or a processor), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

At 402, media device 106 can associate subject catalog metadata 373 with one or more subjects 364 included in multimedia segment 162 received from user 163 who may be a content creator. Subject catalog metadata 373 can be saved in media device 106, which can be provided by user 163 in a separate time. Subject catalog metadata 373 can include information shared by different subjects 364, or any other data deemed as catalog metadata such as used in any shopping catalog.

At 404, media device 106 can place multimedia segment 162 into a content channel 371. In some embodiments, content channel 371 can be assigned to the user 163. Content channel 371 can include a channel name 375 that is associated with user 163, and further includes multimedia segment 162. Content channel 371 can include multiple multimedia segments provided by user 163 at different times. A content channel can also be referred to as a channel. Accordingly, channel 371 can include a collection of multimedia segments that are created by the same user, or related to the same or similar products, objects, services, or subjects. In some other embodiments, content channel 371 can include multimedia segments from multiple users, and are grouped together into channel 371 accordingly to some relationship assigned by media device 106. In some embodiments, media device 106 can further manage multiple content channels, such as channel 371a, channel 371b, channel 371c, channel 371d, and others, where each channel can have a similar structure as channel 371. Multiple channels, such as channel 371a, channel 371b, channel 371c, channel 371d, can form a virtual store, which can be an entity sharing the same or related administration. For example, user 163 can be a department store, channel 371a can include multimedia segments related to dresses for man, while channel 371b can include multimedia segments related to dresses for woman. Media device 106 can provide a platform where shopping merchants can create multiple feeds or multimedia segments and media device 106 can form personized channels to place the multimedia segments in front of targeted users. Accordingly, brands can create their own live channels. For a brand, multiple channels can be created targeting their customers. For example they can create a live channel with an influencer, another live channel with a footage of a super store, etc. Videos are embedded with metadata about the product catalog.

At 406, media device 106 can further present the multimedia segment included in the content channel to mobile device 150 operated by consumer 152. In some embodiments, in addition to mobile device 150, media device 106 can present multimedia segment 162 included in content channel 371 to display device 108 in synchronization with presenting multimedia segment 162 to mobile device 150. In such a situation, consumer 152 and user 132 can be a same person so that consumer 152 can watch media content 113, while buying subjects from content channel 371. Accordingly, a user can watch a display device, e.g., a TV, while operating an app on mobile device 150 at the same time. While a video is displayed on the display device with better images and sound than the mobile device, the associated products shown in the video can be made available to be browsed through the mobile app operating on mobile device 150. In addition, consumer 152 and user 132 can finish the transaction using the mobile device 150 that can have better control in the checkout process for buying the subject than using display device 108 alone. In some embodiments, display device 108 and mobile device 150 can be within a same wireless network so that they can watch the content of multimedia segment 162 over display device 108 while completing a purchase of a subject included in multimedia segment 162 in synchronization with watching the content of multimedia segment 162.

In some embodiments, display device 108 and mobile device 150 may have different computing power. For example, mobile device 150 may support a web browser while display device 108 may not be able to support a web browser or only support a part of the web browser. Accordingly, content channel 371 may be in a format that can be displayed in devices with various computing power, and may be in a format that is not supported by a web browser. Hence, even though content channel 371 includes a collection of multimedia segments, content channel 371 may be different from a web page or e-commerce website including such a collection of multimedia segments.

In some embodiments, media device 106 can further manage multiple content channels generated by different users or related to different subjects. In some embodiments, media device 106 can select content channel 371 assigned to user 163 to be presented to mobile device 150 operated by consumer 152 based on a profile 359 associated with mobile device 150 or consumer 152. In some embodiments, media device 106 can interactively select content channel 371 by first presenting multiple indications of multiple content channels including content channel 371 to mobile device 150, and receiving an indication from consumer 152 for selecting content channel 371 to be presented to the mobile device. For example, media device 106 can present the name or logo of channel 371, channel 371a, channel 371b, channel 371c, channel 371d, to be displayed on mobile device 150 simultaneously. Based on the channel name or logo, consumer 152 can select content channel 371 to be fully displayed on mobile device 150, including displaying multimedia segment 162 included in content channel 371.

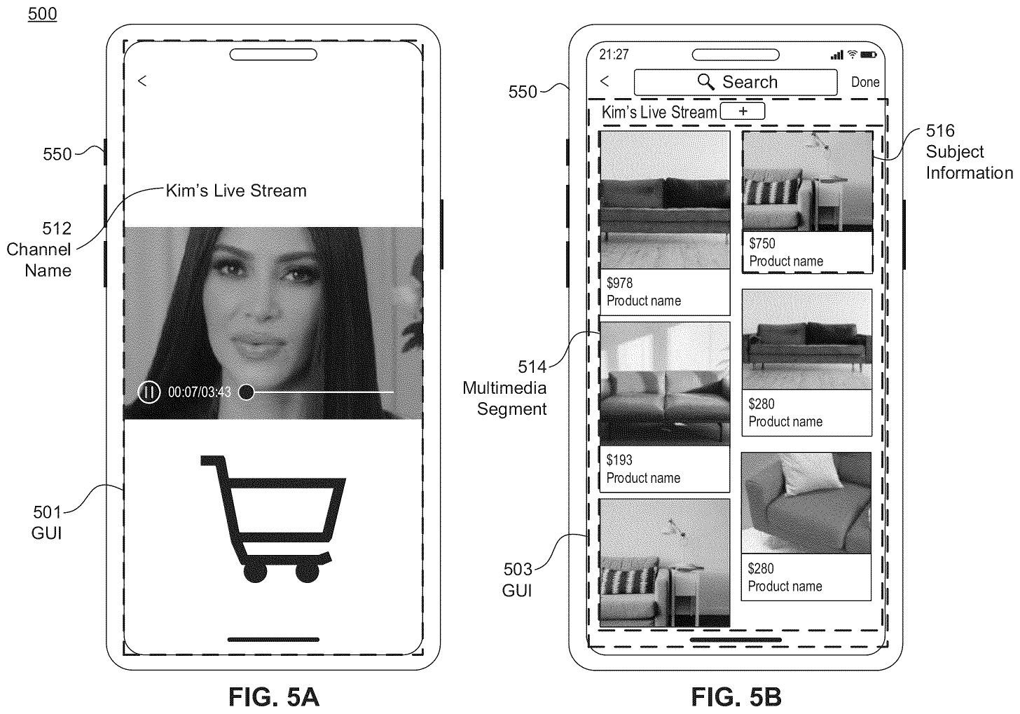

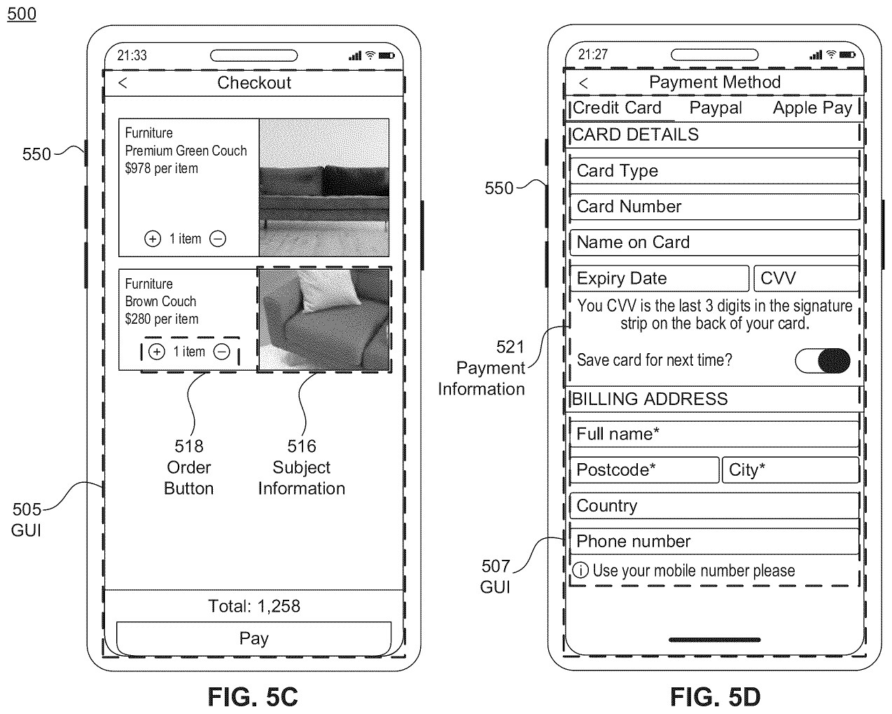

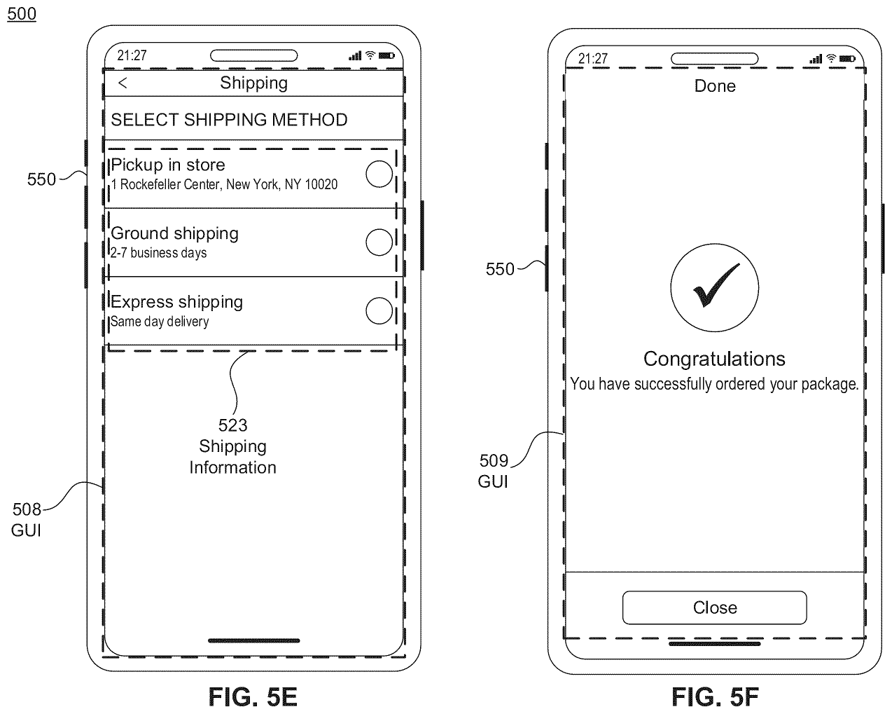

At 408, media device 106 can further place an order 382 for the consumer 152 through mobile device 150 for subject 364 selected from the one or more subjects included in multimedia segment 162 based on the subject catalog metadata 373. In placing the order, media device 106 can send to mobile device 150 further subject information 387 of the one or more subjects 364 for consumer 152 to select the one or more subjects 364 for the order 382. The information 387 of the one or more subjects can include a size of the one or more subjects, a color of the one or more subjects, a quantity of the one or more subjects, a functional feature of the one or more subjects, or a sales promotion information for the one or more subjects, with more details can be shown in FIGS. 5A-5F.

In some embodiments, the order 382 can be generated by mobile device 150 or by media device 106. The order 382 can include consumer information 384 about consumer 152, shipping information 386, or payment information 388. In some embodiments, media device 106 can further receive a consumer input from remote control 110 associated with display device 108 to place another order for subject 364 selected from the one or more subjects included in multimedia segment 162 displayed in channel 371 based on the subject catalog metadata 373. Accordingly, channel 371 can enable placing an order by remote control 110 as well as by mobile device 150. For example, channel 371 may display a “place order” button that can be controlled by a remote control, which is different from a normal web browser based e-commerce.

At 410, media device 106 can process the order 382 to obtain customer information 384, shipping information 386, or payment information 388 for the order 382. Customer information 384, shipping information 386, or payment information 388 for the order 382 can be used by the third party shopping system 140 or media server system 330 to collect the payment and further fulfill the order 382.

At 412, media device 106 can facilitate a payment for the order 382 based on the payment information 388 included in the order 382. In some embodiments, media server system 330, e.g., content sever 120, can include a payment management 331. Payment management 331 can collect payment based on payment information 388 provided at the time the order 382 is generated by mobile device 150. In some embodiments, since media device 106 can be uniquely identified by media account 332, there may be a long term business relationship between the user of media device 106 and media server system 330. Accordingly, the collection of payment for the order 382 can be more flexible than one time transaction that occurs in a normal ecommerce website. In some embodiments, payment management 331 may collect the payment from consumer 152 based on payment information at a time different from the time when order 382 is placed. In addition, payment may be transferred to third party shopping system 140 from media server system 330 at a different time when payment is collected by media server system 330. For example, payment may be transferred to third party shopping system 140 from media server system 330 once a month, or in other time frequency instead of transferring the payment on each order.

At 414, media device 106 can further notify or send a notification 357 by an email or a text message through mobile device 150 to the consumer 152 that the order 382 is placed successfully. In some other embodiments, upon a failure to validate at least a portion of the order by the third party shopping system 140, media device 106 can receive an indication or notification 346 from the third party shopping system 140 that the order 382 is not placed successfully.

In some embodiments, the third party shopping system 140 can receive information from media device 106 or media server system 330, which can include at least a portion of the order 382 and information of media account 332. Third party shopping system 140 can maintain the user shopping account 141 corresponding to the media account 332. Accordingly, the order 382 can be associated with or stored into user shopping account 141. In addition, third party shopping system 140 can validate the portion of the order 382, and further check, by inventory management 343, subject 364 is in stock provided by the third party shopping system 140.

In some embodiments, the third party shopping system 140 can further include an order management 349 that manages the status of the order 382. Order management 349 can include a payment status 348 indicating whether payment for the order 382 has been collected successfully. Order management 349 can also send notification 346 to media device 106 or mobile device 150 to indicate that the order 382 is placed successfully. Alternatively, the third party shopping system 140 can send notification 346 to indicate that the order 382 is not placed successfully if the third party shopping system 140 fails to validate at least the portion of the order 382, there is no inventory available, or the payment fails to be approved.

In some embodiments, media device 106 can receive, upon a successful validation of at least the portion of order 382 by the third party shopping system 140, a confirmation from the third party shopping system 140 that the order 382 is placed successfully. In some embodiments, media device 106 can receive the confirmation after the third party shopping system 140 has validated the portion of the order 382, and the subject 364 is in stock provided by the third party shopping system 140. Afterwards, media device 106 can notify the user the order is placed successfully by an email or a text message to the user, such as sending notification 357 to mobile device 150. In some embodiments, media device 106 can receive, upon a failure to validate at least the portion of the order 382 by the third party shopping system 140, an indication that the order 382 is not placed successfully.

FIGS. 5A-5F illustrate example steps of a process 500 performed by a mobile device 550 to place an order for a subject included in a multimedia segment of a content channel displayed in the mobile device 550, according to some embodiments. Mobile device 550 can be an example of the mobile device 150 of FIG. 1 or 3. Process 500 illustrates operations performed by mobile device 550 in response and corresponding to the operations of process 400 performed by media device 106.

At 501, mobile device 550 may perform operations and display a graphic user interface (GUI) shown in FIG. 5A that includes an indication of a content channel, such as a channel name 512, a logo, photo, and other related information. The content channel is assigned to a user and selected from a plurality of content channels managed by a computing device, such as the multiple content channels managed by media device 106 as shown in FIG. 3.

At 503, mobile device 550 may perform operations and display a GUI shown in FIG. 5B including a multimedia segment 514 which can be received from media device 106. The multimedia segment 514 can include information about one or more subjects, or subject information 516. Mobile device 550 may receive and display the information of the one or more subjects that includes a size of the one or more subjects, a color of the one or more subjects, a quantity of the one or more subjects, a functional feature of the one or more subjects, or a sales promotion information for the one or more subjects.

In some embodiments, the content channel displayed on the GUI at 501 or 503 can be generated in an interactive process. Mobile device 550 can display multiple indications of multiple content channels of the plurality of channels including the content channel shown at FIG. 5A, and receive a selection for displaying the content channel assigned to the user to be presented to mobile device 550.

At 505, mobile device 550 may generate an order for a subject selected from the one or more subjects included in the multimedia segment based on a subject catalog metadata associated with the one or more subjects. As shown in the GUI shown at FIG. 5C, an order button 518 can be shown besides subject information 516 to order the subject.

At 507 and 508, as shown in FIGS. 5D and 5E, to generate the order, mobile device 550 may receive payment information 521 related to a consumer to be included into the order, and receive shipping information 523 to be included into the order for shipping the subject.

At 509, mobile device 550 may display an indication that the order has been successfully generated. Afterwards, mobile device 550 may transmit the order to the computing device such as media device 106 to place the order, and further receive a notification from media device 106 by an email or a text message to indicate that the order is placed successfully.

Example Computer System

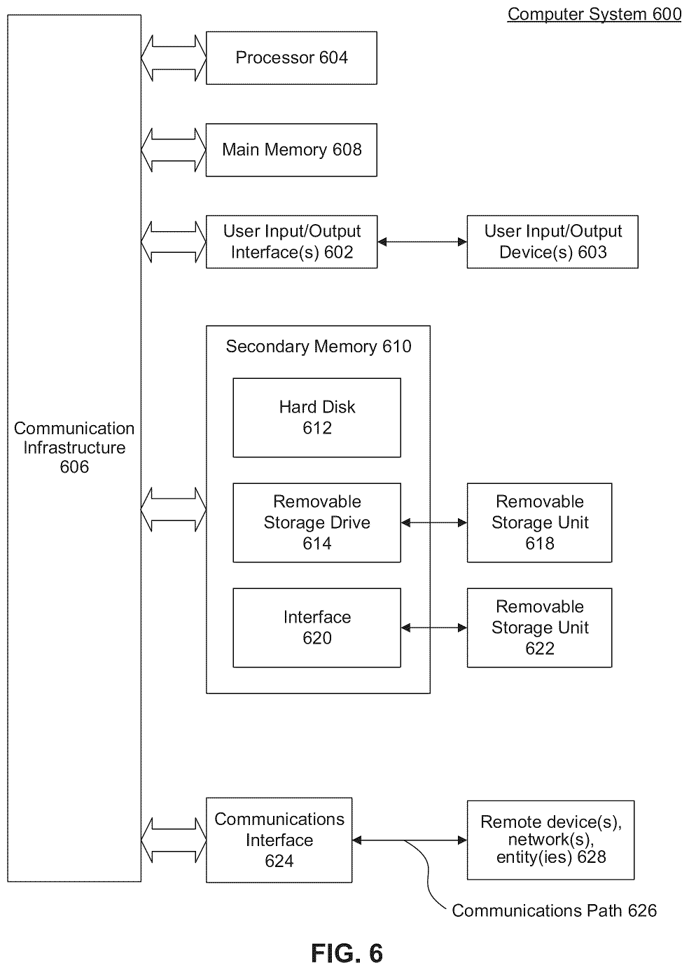

Various embodiments may be implemented, for example, using one or more well-known computer systems, such as computer system 600 shown in FIG. 6. For example, media device 106, display device 108, user device 160, third party shopping system 140, content server 120, system server 126, mobile device 150, mobile device 550, may be implemented using combinations or sub-combinations of computer system 600 to perform various functions described herein, e.g., by process 400. Also or alternatively, one or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600 or processor(s) 604), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method, comprising:
associating, by a computing device, subject catalog metadata with one or more subjects included in a multimedia segment received from a user;
placing the multimedia segment into a content channel assigned to the user;
presenting the multimedia segment included in the content channel to a mobile device operated by a consumer; and
placing an order for the consumer through the mobile device for a subject selected from the one or more subjects included in the multimedia segment based on the subject catalog metadata.

2. The method of claim 1, further comprising:
processing the order to obtain information about the consumer, shipping information, or payment information for the order.

3. The method of claim 1, further comprising:
selecting the content channel assigned to the user from a plurality of content channels to be presented to the mobile device operated by the consumer based on a profile associated with the mobile device or the consumer.

4. The method of claim 1, further comprising:
presenting multiple indications of multiple content channels including the content channel assigned to the user to the mobile device; and
receiving an indication from the consumer for selecting the content channel assigned to the user to be presented to the mobile device.

5. The method of claim 1, wherein the order includes payment information, and the method further comprises:
facilitating a payment for the order based on the payment information included in the order.

6. The method of claim 1, further comprising:
sending, to the mobile device, further information of the one or more subjects for the consumer to select the one or more subjects for the order, wherein the information of the one or more subjects includes a size of the one or more subjects, a color of the one or more subjects, a quantity of the one or more subjects, a functional feature of the one or more subjects, or a sales promotion information for the one or more subjects.

7. The method of claim 1, further comprising:
notifying by an email or a text message through the mobile device to the consumer that the order is placed successfully.

8. The method of claim 1, further comprising:
receiving, upon a failure to validate at least a portion of the order by a third party shopping system, an indication that the order is not placed successfully.

9. The method of claim 1, further comprising:
presenting the multimedia segment included in the content channel to another device in synchronization with the presenting the multimedia segment included in the content of the channel to the mobile device.

10. The method of claim 9, further comprising:
receiving a consumer input from a remote control associated with another device coupled to the computing device to place another order.

11. A mobile device, comprising:
a transceiver configured to wirelessly communicate with a computing device;
at least one controller coupled to the transceiver and configured to:
display a content channel including a multimedia segment received from the computing device, wherein the content channel is assigned to a user and selected from a plurality of content channels managed by the computing device, and the multimedia segment includes information about one or more subjects;
generate an order for a subject selected from the one or more subjects included in the multimedia segment based on subject catalog metadata associated with the one or more subjects; and
transmit the order to the computing device to place the order.

12. The mobile device of claim 11, wherein the at least one controller is further configured to:
display multiple indications of multiple content channels of the plurality of channels including the content channel assigned to the user; and
receive a selection for displaying the content channel assigned to the user to be presented to the mobile device.

13. The mobile device of claim 11, wherein the at least one controller is further configured to:
receive payment information related to a consumer to be included into the order.

14. The mobile device of claim 11, wherein the at least one controller is further configured to:
receive shipping information to be included into the order for shipping the subject.

15. The mobile device of claim 11, wherein the at least one controller is further configured to:
display further information of the one or more subjects to select the one or more subjects for the order, wherein the information of the one or more subjects includes a size of the one or more subjects, a color of the one or more subjects, a quantity of the one or more subjects, a functional feature of the one or more subjects, or a sales promotion information for the one or more subjects.

16. The mobile device of claim 11, wherein the at least one controller is further configured to:
receive a notification from the computing device by an email or a text message to indicate that the order is placed successfully.

17. A non-transitory computer-readable medium having instructions stored thereon that, when executed by at least a computing device, cause the computing device to perform operations comprising:
associating subject catalog metadata with one or more subjects included in a multimedia segment received from a user;
placing the multimedia segment into a content channel assigned to the user;
presenting the multimedia segment included in the content channel to a mobile device operated by a consumer; and
placing an order for the consumer through the mobile device for a subject selected from the one or more subjects included in the multimedia segment based on the subject catalog metadata.

18. The non-transitory computer-readable medium of claim 17, the operations further comprising:
processing the order to obtain information about the consumer, shipping information, or payment information for the order.

19. The non-transitory computer-readable medium of claim 17, the operations further comprising:
selecting the content channel assigned to the user from a plurality of content channels to be presented to the mobile device operated by the consumer based on a profile associated with the mobile device or the consumer.

20. The non-transitory computer-readable medium of claim 17, the operations further comprising:
presenting multiple indications of multiple content channels including the content channel assigned to the user to the mobile device; and
receiving an indication from the consumer for selecting the content channel assigned to the user to be presented to the mobile device.
